(19) United States
(12) Patent Application Publication
(10) Pub. No.: US 2016/0292802 A1
(43) Pub. Date: Oct. 6, 2016

(54) Asset Management Support System

(71) Applicant: Hitachi, Ltd., Tokyo (JP)

(72) Inventors: Yasuyuki TADA, Tokyo (JP); Kazuyasu ASAKURA, Tokyo (JP); Satoru SHIMIZU, Tokyo (JP); Hiromichi KONNO, Tokyo (JP); Masahiro MURAKAMI, Tokyo (JP); Kazutaka JOE, Tokyo (JP)

(21) Appl. No.: 15/064,991

(22) Filed: Mar. 9, 2016

(30) Foreign Application Priority Data
Mar. 30, 2015 (JP) 2015-068453

(51) Int. Cl. G06Q 50/16; G06Q 10/00; G06Q 10/06

(52) U.S. Cl. CPC G06Q 50/163; G06Q 10/0631; G06Q 10/20

(57) ABSTRACT

An asset management support system of the present invention issues a work order to an asset facility for inspection and maintenance and includes a facilities information database that stores inspection and maintenance results, a health index database that stores a state of the asset facility and surroundings around the asset facility as a health index, a comparison function that considers the health index as actual facility status of the asset facility and compares the actual facility status with a maintenance expectation effect estimated from an asset facility state at a time of installation of the asset facility or previous inspection and maintenance, an operation knowledge database that stores operation knowledge of an operator, a maintenance process update function that extracts an operation change of the inspection and maintenance and updates the facilities information database, and a work order issuing function that issues the work order for the inspection and maintenance.

### CLAIM OF PRIORITY

The present application claims priority from Japanese Patent Application JP 2015-068453 filed on Mar. 30, 2015, the content of which is hereby incorporated by reference into this application.

### FIELD OF THE INVENTION

The present invention relates to an asset management support system, and more specifically to an asset management support system that changeably operates inspection content according to the status of on-site facilities, for example.

### BACKGROUND OF THE INVENTION

In these years, in order to improve product quality and to use facilities for a longer time through inspection and maintenance operations and other operations on various facilities, which are company assets, many companies increasingly install asset management support systems constructed based on information technology.

As asset management support systems constructed based on information technology, an enterprise asset management (EAM) (or facility asset management) system, for example, is known. In order to smoothly conduct inspection and maintenance operations, the current EAM systems include a facilities information management database. The database stores information about facilities to be targets for inspection and maintenance operations, inspection items information, inspection timing information, inspection result information, maintenance information, and other items of information. When inspection and maintenance time comes, the system generates data (maintenance procedure data) that defines the framework of maintenance operations (inspection and maintenance operations). The system manages this data as the template of a work order. The template stores and describes specifications for each facility such as inspection and maintenance intervals, inspection and maintenance items, and management values.

Operators who manage various on-site facilities follow the content described in work order templates issued by an EAM system. The operators conduct inspection and maintenance on specified parts of a specified facility on specified time. The operators reflect the result as data on electronic templates in many cases. The data is fed back to and stored in the EAM system.

The following is known as examples of installing EAM systems.

JP 2014-16691 discloses an EAM system applied to a water supply and sewerage system. The EAM system quantifies the states and values of current assets, and supports appropriate maintenance of water supply and sewerage services and planning of replacements from the middle- and long-term viewpoints based on the replacement demand of facilities and budget information.

JP 2004-240642 discloses an EAM system applied to various plants such as a nuclear power plant. This EAM system appropriately evaluates how faulty plant devices affect plant operations even though no aged deterioration is observed, and determines the inspection schemes and timing for devices.

JP 2004-227357 discloses an EAM system applied to a compressor. Even in facilities having a large number of monitoring items, the EAM system finds signs of troubles, and prepares parts to cause the troubles beforehand. Consequently, the EAM system can avoid unplanned spending of money on the facilities to allow planned maintenance management, and can properly diagnose degradation.

As described in the above Patent Literatures, facility asset management using EAM systems is conducted and planned in many fields. These systems adopt schemes designed suitable for facility assets, to which the EAM systems are applied, and use findings and information obtained accordingly for facility plans and asset management.

However, previously existing EAM systems are merely systems that appropriately conduct inspection and maintenance following the operation content planned at the beginning, store findings and information as new result data of inspection and maintenance, and provide the data used for facility plans and asset management later. In other words, the current EAM systems exactly adhere to inspection and maintenance items determined in the stage of planning the systems. However, the systems are not evolvable systems that review and modify the content of work order templates suitable for the status of on-site assets and facilities, for example.

In this regard, the current EAM systems substantially fail to modify and review the content of templates initially planned (information about target facilities for inspection and maintenance operations, inspection items information, inspection timing information, and other items of information) in such a manner that the status of on-site assets and facilities is reflected on these items of information later. For example, inspection items are added or removed from new viewpoints, or three-year cycle inspection is revised to four-year cycle inspection.

Since the soundness of facilities has to be maintained in social and industrial infrastructure, no specifications can be reviewed without rational reasons. In order to review specifications, it is necessary to comprehensively grasp the operating status of facilities as well as to clarify the cause of shortening the lifetime of facilities. However, the current EAM systems include no processes of operation flows to comprehensively grasp the operating status and to clarify the cause.

Supposing that inspection and maintenance processes can be improved by modifying templates, for example, which are necessary to issue work orders, this can curtail the estimated cost of facility maintenance and can reduce investment costs by streamlining facility design. In this regard, reliability centered maintenance (RCM), condition-based maintenance (CBM), and other concepts are proposed for the similar purposes. Their basic ideas are to control the timing of maintenance. The concepts do not include the modification of specifications and maintenance procedure data.

It is an object of the present invention to provide an asset management support system that can provide more highly convenient operations by reviewing the content of templates.

### SUMMARY OF THE INVENTION

An asset management support system of the present invention issues a work order to an asset facility for inspection and maintenance and includes a facilities information database that stores inspection and maintenance results; a health index database that comprehensively grasps, quantifies, and stores a state of the asset facility and surroundings around the asset facility as a health index; a comparison function that considers the health index as actual facility status of the asset facility, and determines a difference of statuses of the asset facility by comparing the actual facility status with a maintenance expectation effect estimated from a state of the asset facility at a time of installation of the asset facility or previous inspection and maintenance; an operation knowledge database that acquires and stores operation knowledge of an experienced operator; a maintenance process update function that extracts an operation change of the inspection and maintenance according to the operation knowledge or the difference of the statuses of the asset facility, and updates the facilities information database with the operation change; and a work order issuing function that issues the work order for the inspection and maintenance using information in the facilities information database that stores the operation change.

According to the present invention, it is possible to provide an asset management support system that can provide more highly convenient operations by reviewing the content of templates.

### BRIEF DESCRIPTION OF THE DRAWINGS

FIG. 1 is a diagram of an exemplary configuration of an asset management support system according to an embodiment of the present invention;

FIG. 2 is a diagram of the stored states of various items of information stored in a health index database DB2;

FIG. 3 is a diagram of a specific comparison example in which a maintenance expectation effect S5 is compared with an actual facility status S4;

FIG. 4 is a diagram of another specific comparison example in which the maintenance expectation effect S5 is compared with the actual facility status S4;

FIG. 5 is a flowchart of example processes of a maintenance process update function P5;

FIG. 6 is a diagram of an example of acquiring health indexes; and

FIG. 7 is a diagram of an example in which it is turned out that an excess margin is provided on the specifications of a facility from the relationship between the maintenance expectation effect S5 and the actual facility status S4.

### DETAILED DESCRIPTION OF THE PREFERRED EMBODIMENTS

In the following, an asset management support system according to an embodiment of the present invention will be described with reference to the drawings.

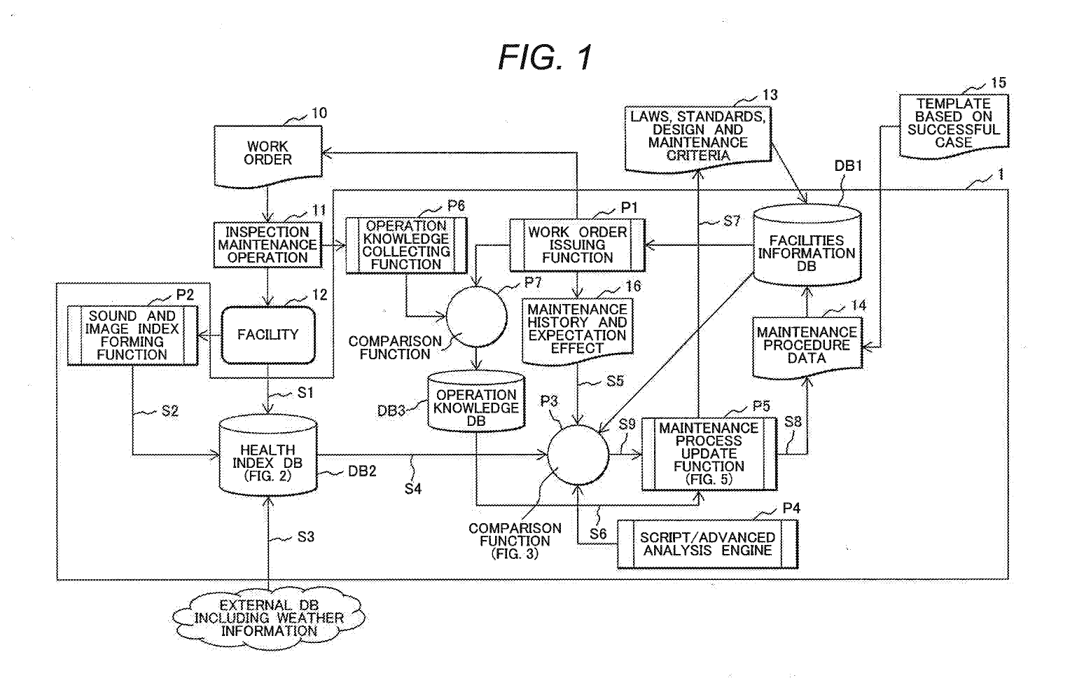

FIG. 1 is a diagram of an exemplary configuration of an asset management support system according to an embodiment of the present invention. The asset management support system according to the embodiment of the present invention is applicable to any types of facilities and assets. Here, an example will be described in which the asset management support system is applied to electric power transmission and distribution facilities owned by an electric power company. FIG. 1 illustrates an asset management support system 1 including databases DB and various process functions P performed inside the asset management support system 1.

In FIG. 1, a facilities information database DB1 in the asset management support system 1 is also used in previously existing EAM systems. In order to smoothly conduct the inspection and maintenance operations of electric power transmission and distribution facilities, the facilities information database DB1 includes information about facilities subject to inspection and maintenance operations, inspection items information, inspection timing information, inspection result information, maintenance information, and other items of information.

In the case of electric power transmission and distribution facilities, target facilities for inspection and maintenance operations are transformers, breakers, switches, reactors, bus lines, and other devices in the compounds of electric power substations, and further include pole transformers, switches, remote terminal units (RTUs) of communication facilities, power transmission lines, electricity distribution lines, and other components. The electric power company has a large number of target facilities for inspection and maintenance operations. Thus, the target facilities are managed in the facilities information database DB1 in a centralized manner together with their installed locations and identification information. Inspection items are specifically defined for each of target facilities for inspection and maintenance operations. The inspection items are defined from the viewpoints such as components (parts), shapes, and characteristics of the facilities. Inspection timing is defined in advance for each of facilities or facility components.

In the items stored in the facilities information database DB1, the target facilities information for inspection and maintenance operations, the inspection items information, and the inspection timing information are items of data (maintenance procedure data) specifying the framework of maintenance operations (inspection and maintenance operations). The inspection result information and the maintenance information are input information obtained as the result of inspection and maintenance.

The items stored in the facilities information database DB1 according to the embodiment of the present invention are basically the same as the items stored in the previously existing EAM systems. However, the system according to the embodiment substantially differs from the conventional ones in that items relating to maintenance procedure data are reviewed and later inspection and maintenance operations are variably conducted.

The stored content of the facilities information database DB1 according to the embodiment of the present invention is updated by reflecting knowledge, various standards and laws, the analyzed result of the cause of failure, and other items of information. The detail of these items of data will be described separately. At any rate, these items of information are reflected on variable operations in later inspection and maintenance operations.

A work order issuing function P1 is basically the same as the function in the previously existing EAM systems. However, the work order issuing function P1 is different from that in the conventional systems in that variable operations of inspection and maintenance operations are considered in it.

According to the conventional EAM systems, typically, a work order 10 is issued at certain time intervals with reference to maintenance procedure data, which is a template that predetermines the content of inspection and maintenance. For example, a work order 10 is issued, the content of which is that a transformer “A” is supposed to undergo a biennial inspection next month and inspection items A, B, and C are checked for the transformer “A”.

Reliability centered maintenance (RCM) and condition-based maintenance (CBM) can adjust the timing of issuing. In the embodiment of the present invention, a work order 10 is issued further from the viewpoint of comprehensive grasping. More specifically, as described later, lifetime is assessed not only on each facility but also on the components of this facility. In addition, environmental information such as geographical and weather information is combined, and the knowledge of the priority of inspection and maintenance operations is used. Thus, a work order 10 is issued with minimizing inspection and maintenance operations and without degrading the reliability of the facility.

An inspection and maintenance operator receives the work order 10 bearing the content of periodic inspection of the transformer “A” on inspection items A, B, and C. The operator performs inspection and maintenance operations 11 on the scheduled items on the scheduled date and time. The inspected result is stored as electronic health index information in a health index database DB2 in the asset management support system 1 according to the embodiment of the present invention illustrated in FIG. 1 together with an operation daily report by the inspection and maintenance operator, for example.

Other than the inspected result, from the viewpoint of comprehensive grasping, the index of electrical characteristic values, which is a first index S1 as health index information, is stored in the health index database DB2. For example, the electrical characteristic values are measurable electrical quantities such as current values and voltage values of a three-phase transformer in the stationary state or in an accident, or rush currents in starting the transformer. For the first index S1, the index of a facility installation environment is stored in the health index database DB2 as health index information. For example, the index is environment items such as a geographical location, a location near to the sea, and strong winds.

Other than the inspected result, from the viewpoint of comprehensive grasping, for a second index S2, indexes other than electrical characteristic values are stored in the health index database DB2 as health index information through a sound and image index function P2. In this case, for example, sounds means sounds in association with the discharge of the transformer. Images mean the vibrations or inclination of the tip end of a bushing, and colors of rust portions, for example.

Other than the inspected result, from the viewpoint of comprehensive grasping, for a third index S3, weather information, for example, is stored in the health index database DB2 as health index information.

Here, these items of health index information (health index values) mean basic information of facility diagnosis. The health index information is the quantified information of the state of on-site devices obtained through inspection, for example. The health index information includes originally quantified values simply through the input from a measuring device as well as quantified values based on five senses such as sounds, rust, and smells. This is the feature of the health index information. In digitization, various techniques are applicable. In the embodiment of the present invention, quantified information is obtained through these techniques.

The first to third indexes S1 to S3 may be measured information on the day of inspection and maintenance operations. Desirably, the first to third indexes S1 to S3 are information reflecting usual states. The first to third indexes S1 to S3 may be planned on the initial system design or may be added in the midway corresponding to operation performances.

Consequently, as health index information, the health index database DB2 obtains the first to third indexes S1 to S3 as quantified information in addition to inspection and maintenance information obtained through inspection and maintenance operations.

Here, the reason that sounds and images are formed in indexes and stored as the second index S2 will be further described. Most abnormalities of electric facilities can be detected by abnormal temperature. This detection by abnormal temperature is conventionally used for facility maintenance in monitoring by making a tour of inspection, for example, or in protective relaying systems. Conventionally, visual information has to be managed in low resolution. However, because of information technology in these years, information can be managed more in detail including changes in a time series.

For example, conventionally, rusting of an outer case installed in the outdoors has to be managed by binary values, presence or absence. The determination is made from a more personal viewpoint of operators, which fails to be used for the loop of maintenance process improvement. With the wise use of information technology, the following is achieved. For example, pictures are taken using a remote terminal, and are stored as raw data in the health index database DB2 as unchanged. With the use of signal processing techniques, indexes expressing the degree of rusting or how rust is developed, for example, can be stored as health indexes in the health index database DB2.

With the use of signal processing techniques, unusual sounds can also be analyzed whether the sounds are simply caused by magnetostriction vibrations or the signs of degradation of an insulator, for example. The states of facilities can be estimated through changes in the health index of sounds in a time series.

In future, with the advancement of various sensor techniques, forming indexes can be expected from various viewpoints (e.g. offensive smalls). The system can flexibly store index data in the health index database DB2.

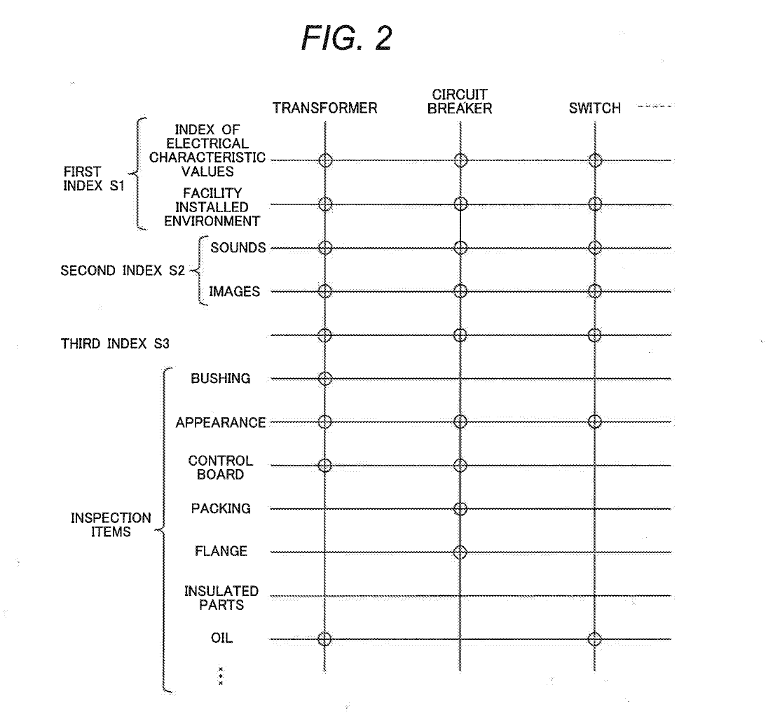

FIG. 2 is a diagram of the stored states of various items of information stored in the health index database DB2. Various stored items of information are stored at sites corresponding to intersection points vertically and horizontally illustrated in FIG. 2. In FIG. 2, the horizontal axis expresses target facilities for inspection and maintenance operations. These target facilities include transformers, breakers, switches, reactors, bus lines, and other devices in the compounds of electric power substations, and further include pole transformers, switches, remote terminal units (RTUs) of communication facilities, power transmission lines, electricity distribution lines, and other components. Here, all facilities owned by an electric power company are described. In FIG. 2, transformers, breakers, and switches are described as typical examples.

In FIG. 2, the vertical axis expresses the index of electrical characteristic values and a facility installation environment item as the first index S1, the second index S2, and the third index S3. The vertical axis also expresses inspection items on target facilities for inspection and maintenance operations. The inspection items are specifically defined for each of the target facilities for inspection and maintenance operations, which are defined from the viewpoints including components (portions and parts), shapes, states, and performances of the facilities. Examples in FIG. 2 are bushings, appearances, control boards (including switchboards and local panels), packings, flanges, insulated parts, and oil, for example.

In FIG. 2, circles on the intersection points mean that the device has information such as inspection and maintenance items and indexes on the intersection points and includes some items of information about inspection and maintenance. For example, the transformer has a bushing, but the breaker has no bushing. Thus, the intersection point of the transformer with the bushing has a circle, whereas the intersection point of the breaker with the bushing has no circle.

The feature of the health index database DB2 is in that target facilities for inspection and maintenance operations are not based on such viewpoints such as the same types and places. Previously existing databases are prone to perform hierarchical sorting using a hierarchy system from the viewpoints such as the same devices and places for hierarchical checking based on maintenance processes. However, in the embodiment of the present invention, any facilities that include devices having packing structures for inspection items can be compared with one another, not based on each of facilities. Another feature of the database DB2 according to the embodiment of the present invention is in that information is comprehensively collected based on the first to third indexes S1 to S3 in addition to inspection items. Consequently, a multi-dimensional database is constructed based on the concept of data mining. Thus, the multi-dimensional database allows forming inverted indexes under specific conditions and comparing a plurality of facilities, and allows comparison of correspondence based on a strong correlation.

Next, referring to FIG. 1, a comparison function P3 will be described. This is a function that compares a maintenance expectation effect S5 with an actual facility status S4.

For example, the maintenance expectation effect S5 assumes a proper state of the transformer “A”, which is a facility for inspection and maintenance, on the next inspection and maintenance considering the status of the transformer “A” when installed and the later operating status and later inspection and maintenance status of the transformer “A”. The maintenance expectation effect S5 is estimated from past (previous) information obtained by referring to information items on the transformer “A” stored in the facilities information database DB1 when the work order issuing function P1 instructs the inspection and maintenance of the transformer “A”. A maintenance history and expectation effect function 16 in FIG. 1 assumes proper states (values) of various health indexes on the next inspection and maintenance time in cooperation with the work order issuing function P1.

The actual facility status S4 is data (a health index) expressing the current state of the transformer “A” obtained on the health index database DB2. In the process of the comparison function P3, the content of the facilities information database DB1 can be used for highly accurate estimation by appropriately making reference.

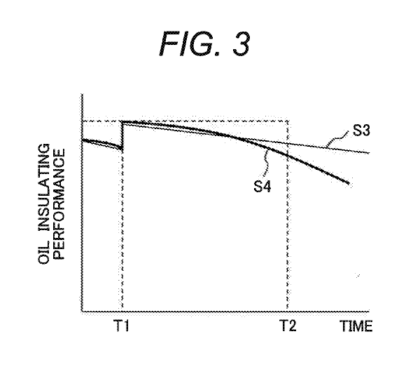

FIG. 3 is a diagram of a specific comparison example. For example, as for the insulating characteristics of insulating oil inside the transformer “A”, insulating oil is replaced at previous inspection and maintenance time T1, and the characteristics are then improved. In this case, the maintenance expectation effect S5 assumes a thin solid line for the state at inspection time T2 at this time based on the replacement of insulating oil and the degradation of the characteristics after improved. However, supposing that the actual facility status S4 is detected as a thick solid line, it can be determined that the insulating oil is degraded beyond prediction.

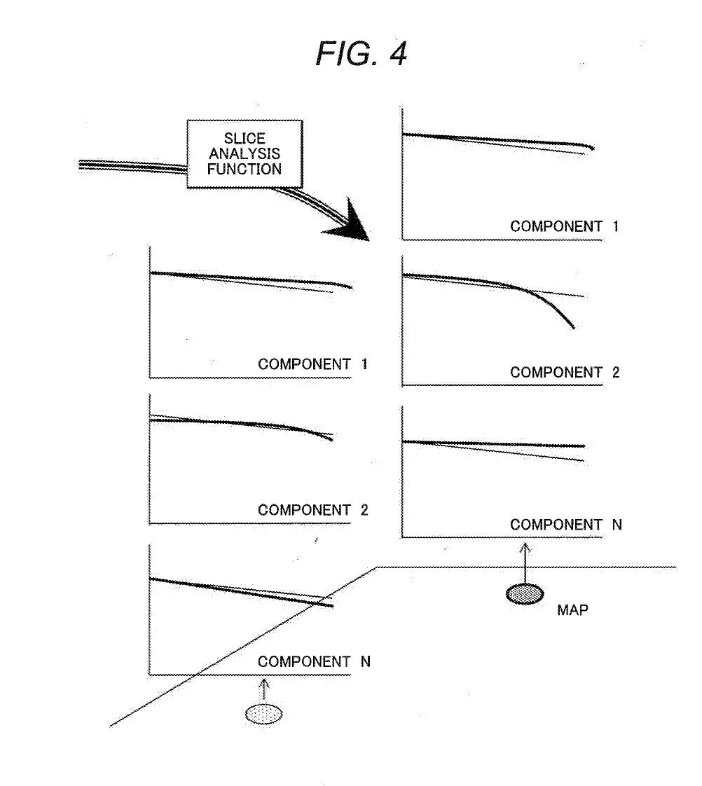

FIG. 4 is a diagram of another specific comparison example. For example, the transformer “A” is not diagnosed only by the state of one point of the insulating oil, but is diagnosed by arraying and comparing the states of plural components at plural places with one another for comprehensive determination. Alternatively, it is also possible to compare the status of the insulating oil in the transformer “A” with that in another unit. It is effective to introduce the concept of slice analysis, which is an analysis method based on plural viewpoints as described above. Thus, it is possible to determine whether the state is a particular abnormality or the state is often observed based on the tendency of changes in the insulating oil in overall facilities. In FIG. 4, in the right case, the degree of degradation is variably estimated based on information that this facility is located near the sea on the map, for example.

In the case of estimation of the maintenance expectation effect S5, since the tendency of degradation over time is shown in many cases, the characteristics of declining in value over time are assumed. The use of various analysis functions is effective in estimating the degree of declining in value over time. FIG. 1 illustrates the scene in which a script/advanced analysis engine function P4 is used.

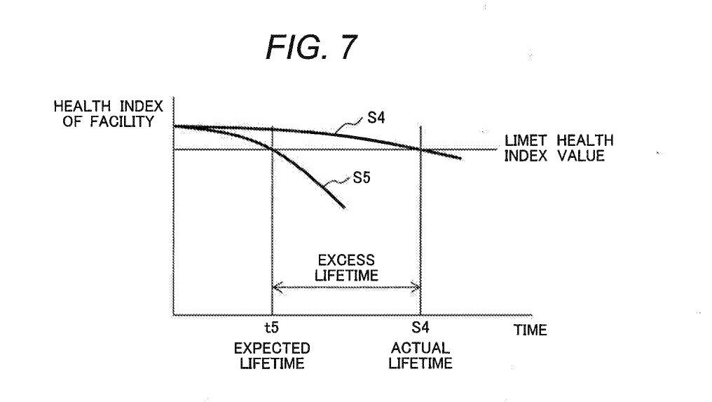

FIG. 7 is a diagram of an example in which it is turned out that an excess margin is provided on the specifications of a facility from the relationship between the maintenance expectation effect S5 and the actual facility status S4. The vertical axis expresses the health index value of a certain facility. The horizontal axis expresses time.

In FIG. 7, the maintenance expectation effect S5 assumes that a limit health index value is reached at time t5 and lifetime reaches the end (expected lifetime). However, from the actual facility status S4, which is actually measured, it is confirmed that the limit health index value has an enough margin at time t5. From the estimation of the actual facility status S4, it is time t4 at which the limit health index value is reached and lifetime actually reaches the end (actual lifetime).

In this case, the actual lifetime reaches the end at time t4. Consequently, it is likely that the specifications of the facility whose lifetime will reach the end at time t5, which is shorter than at time t4, are overdesigned. When the overdesigned specifications are far beyond errors, the facility specifications have to be reviewed to have reasonable values. Such facilities are repaired after appropriate tests and inspection, which can lead to reduction in facility investment.

The comparison function P3 is described with specific examples. The comparison function P3 can be expanded as below when used in advanced manners.

The comparison function P3 is a function that compares the maintenance expectation effect S5 with the actual facility status S4. In this case, the actual facility status S4 corresponds to the health indexes of asset facilities. The health indexes of asset facilities are organized in detail by the health index database DB2 that can appropriately reflect the hierarchical structure of facilities and by the sound and image index function P2 that forms sound and image information into health indexes. Consequently, expectation effect by maintenance can be compared with the actual facility status, which is difficult in previously existing systems, using automatic calculation functions by IT techniques without manpower. These functions can be achieved, because health indexes are thoroughly formed.

In analyzing the difference between the expectation effect and the actual facility status illustrated in FIGS. 3 and 4, target facilities have their lifetime assumed when designed or when maintenance is conduced. Thus, the expected lifetime curve can be compared with an actual facility KPI (Key Performance indicators) over time. The health index database DB2 hierarchically manages information for analyzing the cause of failure or the cause of the event of the facility. The health index database DB2 can break and handle facilities into multi-dimensional structures, and can multi-dimensionally analyze relevance to facility components, weather, local information about installed regions, and other items of information using the slice function. With the use of the health index database DB2, the actual health indexes of actual facilities can be compared with expectation health indexes based on design and maintenance.

The comparison function P3 can be used for the following case. For example, the comparison function P3 can be expanded in such a manner that from the analyzed result of the correlation of relevance, the comparison function P3 makes a list of maintenance content to reduce failures or a decrease in facility performance and automatically calculates the difference to maintenance procedure data in the current state. The comparison function P3 can be expanded in such a manner that the comparison function P3 updates the content of existing maintenance procedure data based on the automatically calculated result.

From hierarchically analysis, components that are prone to fail are extracted, components that are prone to fail are shared in the entire system, and the occurrence of similar failures is predicted. Consequently, the facility maintenance costs can be reduced. Through the process, only some of components are repaired using the slice analysis function on the monitoring content of each of facility components, which allows the determination whether an enough lifetime can be provided.

The comparison function P3 can be implemented by automatic calculation when findings are provided enough. However, at the beginning, the relationship between the environment and components is unknown in processing by the system, and trial and error is sometimes necessary based on abundant experience by humans. Trial and error can be implemented by sequentially inputting commands as well as can form processes of defining relationship through batch processing using scripts.

It is necessary to flexibly process information. Thus, an advanced analysis engine can be easily called from the interface of the script/advanced analysis engine function P4.

Next, a maintenance process update function P5 in FIG. 1 will be described.

Based on comparison information S9 between the actual facility status S4 and the maintenance expectation effect S5 on the health index database DB2, the maintenance process update function P5 calculates how to review maintenance processes and appropriately calculates identification and improvement methods for components to be improved from the viewpoints of cost efficiency, feasibility, continuity, and reliability. The maintenance process update function P5 reflects information on reviewing maintenance processes including operation knowledge information S6.

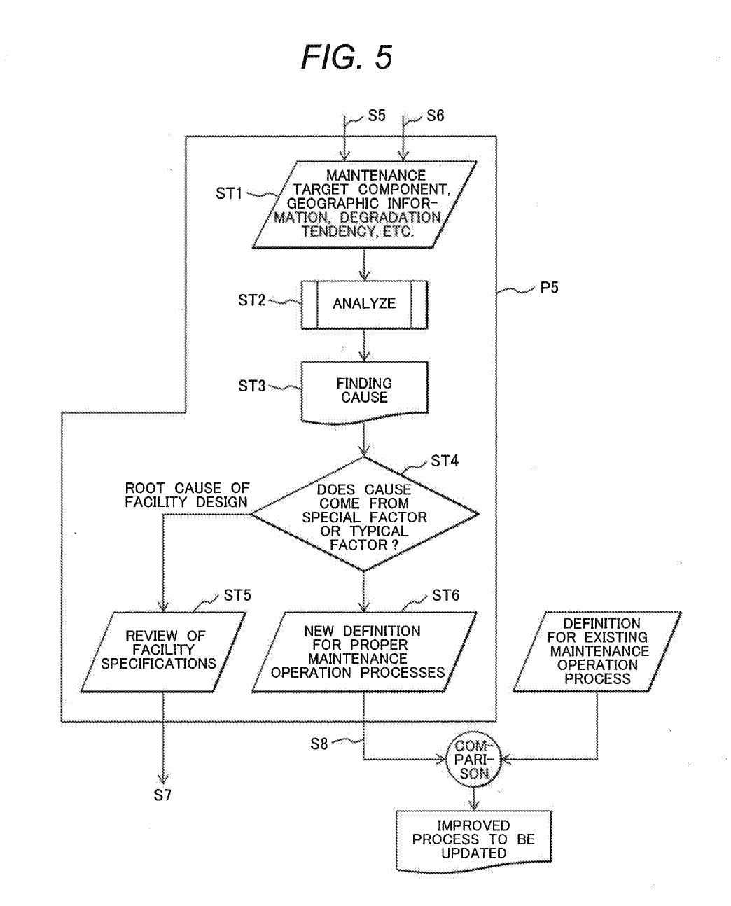

FIG. 5 is a flowchart of an example of processes of the maintenance process update function P5. Here, the comparison information S9 and the operation knowledge information S6 are handled. Thus, the acquisition of the operation knowledge information S6 is first described.

In FIG. 1, an operation knowledge collecting function P6 is illustrated. It is considered that experienced operators have operation knowledge. The operation knowledge collecting function P6 is meant to extract and effectively use the operation knowledge in later inspection and maintenance operations.

The knowledge owned by experienced operators is distinguished from a so-called know-how as below. First, knowledge and know-how are both supposed to be categorized into findings (acquaintance obtained through experience and information). Knowledge means relevant information indicating that if A then not B, which does not include specific analysis processes, methods, and calculation techniques. Know-how means ways to conduct operations and jobs. Knowledge includes two forms, tacit knowledge and explicit knowledge, and can be easily formed in explicit knowledge by language. Know-how also includes two forms, tacit knowledge and explicit knowledge, but is difficult to be formed in explicit knowledge by language. Know-how in explicit knowledge forms is verbalized in forms including manuals (procedures), operation standard processes, rules, and criteria. Here, operating processes formally express the procedures of Operation & Maintenance (O & M), data flows, and product flows. Processes that are systematically standardized are also operation standard processes, and are targets for computerization.

With the use of the system according to the embodiment of the present invention in FIG. 1, it is also possible that information owned by operators who do not even recognize their own information is discovered and organized into knowledge. The importance of the experienced operator's knowledge is that experienced operators appropriately work considering the situations and appropriately review their operations according to their discretion. It is possible to store what situations they find important as knowledge by analyzing the daily work of experienced operators.

The experienced operator's knowledge includes a lot of tacit knowledge that is difficult to be appropriately expressed in a language by experienced operators. Thus, it is useful to analyze the experienced operator's knowledge through objective ways such as information technology. For example, in making a tour of inspection, even though the checked result is the same, experienced operators often observe facilities from multifaceted viewpoints. The experienced operators think that the multifaceted observation of facilities is normal routines and that every operator does the same thing. However, if operators only record the check results of presence or absence of abnormalities on work orders, valuable knowledge of experienced operators may be lost.

On the other hand, if operators have to make many reports, this obviously causes the degradation of working efficiency. In the embodiment of the present invention, the findings of experienced operators can be acquired using information technology. For a specific example, the operation routes of experienced operators are recorded using existing techniques such as the Global Positioning System (GPS) and IC chips and are compared with each other. The operation routes are compared with information recorded on the health index database DB2 and other databases, and the validity of the action of experienced operators is evaluated. Based on the result, maintenance procedure data is updated.

In FIG. 1, for example, the operation knowledge collecting function P6 records the operation route of the experienced operator using existing techniques such as GPS and IC chips. A comparison function P7 makes reference to the work order issuing function P1, finds an operation route assumed for inspection items A, B, and C at this time, and compares this operation route with the actual operation route of an experienced operator. Consequently, for example, it is confirmed that the experienced operator reads measuring gauges X and Y prior to starting the inspection item B. However, a typical unexperienced operator conducts operations just according to manuals and does not read measuring gauges X and Y prior to starting the inspection item B. The experienced operator is unaware of his/her action that has some meaning. Thus, the comparison function P7 stores this action in an operation knowledge database DB3. The operation knowledge database DB3 inputs operation knowledge information S6 to the maintenance process update function P5.

In the flowchart of improving maintenance processes in FIG. 5, in the process of the maintenance process update function P5, various items of information are obtained in process step ST1, which is the first step. Various items of information include the operation knowledge information S6 from the operation knowledge database DB3 and the maintenance expectation effect S5 from the comparison function P3. In addition to this, maintenance target components, geographic information, degradation tendency, and other items of information are used.

In the process of the maintenance process update function P5, failures are analyzed in process step ST2, which is an analysis process, and the cause is found in process step ST3. Consequently, new review information is obtained for the improvement of maintenance processes. These items of information include adding a component that possibly causes a facility failure, reviewing maintenance procedure data, and reviewing laws, standards, or design criteria. These items of review information are categorized in process step ST4 from the viewpoint whether the cause is resulted from a special factor or from a typical factor.

From the categorized result, in the case in which the cause is resulted from a typical factor, the cause is a problem involved in a root cause of facility design. Finally, in process step ST5, reviewing facility specifications S7 is given. In the case of reviewing facility specifications S7, it is necessary to review standards and design. Thus, the asset management support system 1 provides information outside the system. The information is checked against various laws, standards, design and maintenance criteria 13, and then new specifications are again registered in the facilities information database DB1.

From the categorized result, in the case in which the cause is resulted from a special factor, finally in process step ST6, a new definition S8 is proposed which is a proper maintenance operation process. The new definition S8 is compared with definitions for the existing maintenance operation process and, as an improved process to be updated, is finally registered again in the facilities information database DB1, expressed in a form of maintenance procedure data 14.

This is the flow of the flowchart of the improvement of maintenance processes in FIG. 5. New review information (adding a component that possibly causes a facility failure, reviewing maintenance procedure data, and reviewing laws, standards, or design criteria) for improvement of maintenance processes will be further separately described.

First, in adding a component that possibly causes a facility failure, a component that possibly causes a facility failure is analyzed based on failure information described in the health index database DB2, and a weak point of facilities is clarified. For the analyzed result, the cause of failure of individual facilities is hierarchically stored for each of facility components. For example, the destination of storage is the health index database DB2. More specifically, a pole transformer is taken as an example. The components such as an outer case, insulator, iron core, winding wire, insulator, and insulating oil are organized into a hierarchy. It is preferable to add the characteristic correlation between the component failures and maintenance items and the installed regions and the cause of failure as well as the relevance to phenomena when each component is malfunctioned as knowledge.

Next, in reviewing maintenance procedure data, for example, as a comparison result from the comparison function P3, a significant relationship is clarified between rusting of certain component and a facility failure. This relationship has not been assumed. Thus, typically, the existing maintenance procedure data 14 does not have a process of recording the rusting state of this component. In this case, this maintenance procedure is newly generated and recorded. Consequently, such similar failures can be reduced to zero without adding a large operating load, compared with existing maintenance processes.

With the use of such primitive functions as well as comparison of quantified health indexes, an advanced writing function of maintenance procedure data below can also be implemented. In this case, the design lifetime of electric power cables is assumed to be 40 years on the condition that they are installed in recommended environments. The knowledge of the system in a certain line accumulates knowledge in which water present in underground cable tunnels increases a risk caused by water treeing by 1.8 times.

In this case, the reviewed result of maintenance procedure data 14 is as follows. First, maintenance operations of water drainage in tunnels are newly enumerated by high priority. Subsequently, since the lifetime of the cable is 1/1.8 in the worst scenario, replacement intervals are shortened. Subsequently, the inspection interval is shortened to 1/1.8, and then it is confirmed whether the degradation of the key performance indicator KPI is the same as the estimated risk. In the case in which this power cable is important on system operations, it is also difficult to adjust replacement operations. Consequently, constraints on facility operations are updated to lower the degree of importance of the cable.

Next, in reviewing laws, standards, or design criteria, in this case, adjustment is necessary among many stakeholders. Thus, in the system according to the embodiment of the present invention, automatically rewriting data content is unsuited.

Thus, only an administrator is informed. However, information organized based on facts useful for adjustment can be provided. It might be determined that the cause of failure is not appropriately reflected on the phenomenon rather than maintenance processes. In this case, it is also possible to review maintenance processes as well as design and maintenance criteria. More specifically, when facilities are degraded more slowly than the design content, the system allows a scheme in which factors of causing slowness are analyzed, and then design is streamlined. As a secondary effect of the function, when facilities are removed because of relocation, for example, the removed facilities can be reused if having enough lifetime.

By a series of processes illustrated in FIG. 1, the facilities information database DB1 accumulates various findings and new process procedures, for example. Through more experience, this intelligence is more improved.

As described in the chapter of Background, the importance of establishing operation flows to update templates stored in the maintenance procedure data 14 is socially clearly perceived. However, in the maintenance of important social infrastructure, determination tends to be conservative. Thus, administrators have to construct a reliable system. In other words, administrators have to monitor and analyze facility data systematically in excellent objectivity.

In the embodiment of the present invention, novel technical components below are established to solve the problems. The components are implemented by the work order issuing function P1 that can assign priority, the health index database DB2 that can appropriately reflect the hierarchical structure of facilities, the sound and image index function P2 that forms sound and image information into health indexes, the comparison function P3 that compares the maintenance expectation effect S5 with the actual facility status S4, the maintenance process update function P5, the knowledge collecting function P6 that collects the knowledge of operators, and other functions.

The outline of the embodiment of the present invention is to organize various factors of degradation of facilities into information by advanced analysis techniques, and to reflect the information on maintenance plans. Consequently, maintenance processes are streamlined without degrading electricity distribution KPI.

The functions of the components will be further described below. Specifically, the facilities information database DB1 that reflects findings finally obtained and the work order issuing function P1 will be further described.

First, the work order issuing function P1 that can assign priority will be described. In the case in which specific knowledge is obtained, the work order issuing function P1 reflects the knowledge in later processes. Examples of knowledge in this case are as follows, showing numeric values, which are merely examples.

Knowledge 1: If facilities are located places far from the sea, the facilities do not need maintenance for 36 months. The periodic inspection interval is 24 months. In case of failure, the facilities are less affected.

Knowledge 2: The main factor of facility failure is the degradation of the rubber packing of a control board. Statistically, the function of rubber packings can be maintained for 24 months. The influence of rubber packings in failure is serious.

Under the conditions above, the following case will be assumed in reflecting the knowledge in later processes. First, with the use of knowledge 1, the inspection intervals of the maintenance operations of facilities located considerably far from the sea can be extended without degradation of the reliability of electricity transmission and distribution lines. With the use of knowledge 2, before the subsequent periodic inspection, control boards can be inspected together with control boards in facilities at locally or electrically near locations. For example, such an occasion comes in 20 months after previous inspection, the work order 10 can be issued forward, from the viewpoint of reducing costs for preparing inspection operations. By simulation, it is possible to know beforehand that maintenance operations will be busy in a certain period. However, busy maintenance operations are likely to increase in operator costs. Maintenance operations are preferably leveled. The use of knowledge allows the leveling of operations.

Next, the facilities information database DB1 that provides basic data to be referenced in determining priority will be further described.

The facilities information database DB1 stores the common attribute data of facilities as well as the inspection and maintenance manuals, various standards, laws, the analyzed result of component failure, and other items of data. Knowledge-based work order issuance can be rationally implemented by solving calculations for the purpose of cost reduction mainly on the constraints of the reliability of maintenance.

To this end, previously existing work order issuing functions similarly issue work orders for each of facilities at constant time intervals based on maintenance criteria preset by an electric power company. However, according to the embodiment of the present invention, the work order issuing function is additionally provided with knowledge. Consequently, information such as maintenance procedure data, the analyzed result of facility component failure, and the laws of countries is organically used, and thus facilities can be used up to their lifetime through maintenance in a minimum necessary amount with the priority of facilities and the degree of importance.

The content of the maintenance procedure data 14 is improved together with the accumulation of knowledge. Thus, the system according to the embodiment of the present invention only allows improvement step by step. However, when universal knowledge based on previous cases is available, the system according to the embodiment of the present invention can provide a short accumulation period of knowledge, which is valuable. Prompt improvement can be achieved by introducing a template 15 based on a successful case in FIG. 1 into the maintenance procedure data 14 for reflection. International standards have to be taken into account in externally providing the facilities information database DB1 that is configured of the maintenance procedure data 14, the analyzed result of facility component failure, and other items of information.

After work orders are issued, the facility maintenance operations are the same as the procedures in the current state. Consequently, the system according to the embodiment of the present invention produces no new load on the field side.

It is clarified that the work order 10 is issued for what effect is expected. Thus, the history of the work orders 10 is managed, and the facility state expected by a manager can be managed as a theoretical facility KPI.

For the situations of using the system according to the embodiment of the present invention, for example, the operation mode is switched to an emergency mode in which the top priority is restoration from disasters in restoring facilities in large-scale disasters (e.g. earthquakes and typhoons). Under this mode, work orders are issued by priority to socially important facilities (e.g. hospitals, fire departments, and police facilities), allowing civil disorder to be at the minimum.

The work orders 10 are issued using the improved maintenance procedure data 14. Consequently, work orders that implement O & M similar to experienced operators and engineers can be issued. Thus, knowledge like senses to facilities from a broad perspective of humans can be quantitatively handled. However, in order to accumulate human experience as knowledge, it is important to automatically accumulate the operation content based on the discretion of the operation by operators in compliance with work orders depending on the degree of skills.

Next, the health index database DB2 that can appropriately reflect the hierarchical structure of facilities will be further described.

According to the embodiment of the present invention, the states of facilities are formed into indexes as the health indexes of facilities, and stored in the health index database DB2. Conventionally, information is managed using paper documents. Forming indexes allows the calculation of information to be provided for the maintenance procedure data 14 used in the facilities information database DB1 and for facility component failure analysis. With the adoption of mobile terminals, health indexes can be formed by directly inputting the result observed by operators as electronic information. Preferably, an interface to external computer systems is provided in order to store health indexes that need analysis.

The system according to the embodiment has a flexible system configuration that can flexibly mount calculation components if calculation findings are available. The system has high expansiveness with interfaces. Thus, the system can manage health indexes that fail to be observed directly.

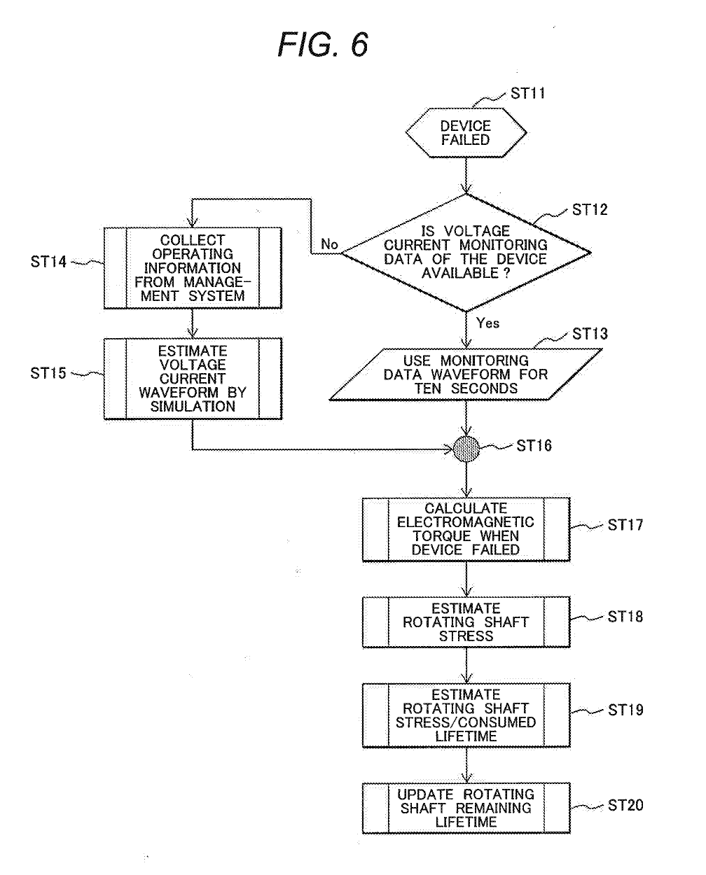

For example, some items have to be subjected to circuit analysis like the consumed lifetime of the shaft of a rotary machine in association with the failure in electricity transmission and distribution lines. These items can be automatically updated like the acquisition of the health index in FIG. 6. For example, fluctuations in a voltage or electric current in failure and the configuration of electricity transmission and distribution lines when the failure occurs are combined with a system that can estimate the consumed lifetime of the shaft from circuit analysis and torque fluctuations. Thus, items relevant to the health indexes of rotary machines can be automatically updated.

In estimation of the consumed lifetime of the shaft in FIG. 6, the process is started in process step ST11 under the conditions that electricity transmission and distribution lines fail. In process step ST12, it is determined whether the past monitoring data of the voltage and electric current of the rotary machine is available. When the past monitoring data is available, in process step ST13, monitoring data waveforms are used for ten seconds, for example. In the case in which monitoring data waveforms are unavailable, in process step ST14, operating information is collected from the management system of electricity transmission and distribution lines. In process step ST15, voltage and current waveforms are estimated by simulation.

In the case in which data is obtained in process step ST16, the following is sequentially performed: the calculation of the electromagnetic torque of the rotary machine when electricity transmission and distribution lines failed (process step ST17); the estimation of rotating shaft stress (process step ST18); the estimation of rotating shaft stress/consumed lifetime (process step ST19); and the update of the rotating shaft remaining lifetime (process step ST20). Consequently, the items of the health index of the rotary machine are automatically updated.

The update of the health index database DB2 as described above can be performed in various scenes below. Preferably, the update is triggered by updates after reflecting a tour of inspection or maintenance operations, after analyzing an event triggered by the occurrence of failure, or after recording information continuously collected as a kind of log, for example.

The health index database DB2 can store asset facilities as well as environments in which the asset facilities are installed (e.g. high humidity, fast wind velocities, locations near to highways, and the states of neighboring factories), which are formed into indexes in cooperation with one another.

On the other hand, facilities can be used and handled when components in failure are repaired. Therefore, it is important to manage the health indexes of the individual components of facilities. In the previously existing facilities information databases, facilities themselves are used as keys to manage the attributes of individual components. This structure is difficult to make searches below.

For example, the rubber packing of a control box storing a control board is prone to be degraded in a specific environment. In this case, when control boxes are organized from the viewpoint of facility components, this fails to extract the typical characteristics of control boxes not based on facilities. Findings, which can be originally used for comprehensive rules of facility maintenance as common findings, might be dwarfed to local rules for each facility.

Therefore, as illustrated in FIG. 2, in order to easily search for facility components themselves on common concepts, component groups configuring facilities are correlated with one another in a common layer, under the conditions that from the viewpoint of usage, components having the same functions are equivalent. Consequently, attribute values can be managed so that facility components can be searched from the viewpoints of facilities as well as components. This information management method allows easy extraction. For example, among different facilities such as switches and information transmitters, a common factor, which is the degradation of a control box packing in specific environments, can be easily extracted.

Naturally, for local environmental information of regions in which facilities are installed as well as external factors such as weather information in the entire region and other items of information, interfaces are appropriately applied to establish appropriate links with geographic information systems (GIS) and other systems so that information already published on the Internet can be effectively used. Thus, various items of information constructed by other persons and organizations can be used as the components of the health index database DB2 of the system according to the embodiment.

Indexes, which are simply formed by one to one correlation of the observed result with a facility, fail to be used as sufficient health indexes. In the embodiment of the present invention, facilities can be correlated with indexes for each component in the slice structure in many fields. Thus, complex factors of facility degradation can be clarified in combination of general-purpose techniques such as risk mapping.

### EXPLANATION OF REFERENCE CHARACTERS

1: Facility management support system
10: Work order
11: Inspection and maintenance operations
12: Target facility for inspection and maintenance
13: Laws, standards, design and maintenance criteria
14: Maintenance procedure data
15: Template based on a successful case
DB1: Facilities information database
DB2: Health index database
DB3: Operation knowledge database
P1: Work order issuing function
P2: Sound and image index function
P3: Comparison function
P4: Script/advanced analysis engine
P5: Maintenance process update function
P6: Operation knowledge information collecting function
P7: Comparison function
S1: First index
S2: Second index
S3: Third index
S4: Actual facility status
S5: Maintenance expectation effect
S6: Operation knowledge information
S7: Reviewing facility specifications
S8: New definition for a proper maintenance operation process
S9: Comparison information

What is claimed is:

1. An asset management support system that issues a work order to an asset facility for inspection and maintenance, the system comprising:
a facilities information database that stores inspection and maintenance results;
a health index database that comprehensively grasps, quantifies, and stores a state of the asset facility and surroundings around the asset facility as a health index;
a comparison function that considers the health index as actual facility status of the asset facility, and determines a difference of statuses of the asset facility by comparing the actual facility status with a maintenance expectation effect estimated from a state of the asset facility at a time of installation of the asset facility or previous inspection and maintenance;
an operation knowledge database that acquires and stores operation knowledge of an experienced operator;
a maintenance process update function that extracts an operation change of the inspection and maintenance according to the operation knowledge or the difference of the statuses of the asset facility, and updates the facilities information database with the operation change; and
a work order issuing function that issues the work order for the inspection and maintenance using information in the facilities information database that stores the operation change.

2. The asset management support system according to claim 1,
wherein the health index includes at least one of installed environment, weather information, sound information, and image information.

3. The asset management support system according to claim 1,
wherein the health index database stores a component of the asset facility, an inspection item described in the work order, and the health index, and is cross-searchable.

4. The asset management support system according to claim 1,
wherein the maintenance process update function presents necessity of review when the maintenance process update function determines that a specification of the inspection and maintenance of the asset facility needs a review based on the operation knowledge or a cause of the difference of the statuses of the asset facility, and
wherein the facilities information database stores an approved content after the review.

5. The asset management support system according to claim 1,
wherein the maintenance process update function creates a new improved process when the maintenance process update function determines that a new definition is needed for a proper operation process of the inspection and maintenance based on the operation knowledge or a cause of the difference of the statuses of the asset facility, and
wherein the facilities information database stores the improved process.
